(19) United States
(12) Patent Application Publication
(10) Pub. No.: US 2008/0197705 A1
(43) Pub. Date: Aug. 21, 2008

(54) System including a microturbine and a high-frequency alternator generating backup power for a telecommunications system

(76) Inventors: David W. Dewis, Stuart, FL (US); Quincy Q. Wang, West Palm Beach, FL (US)

Correspondence Address: NORMAN FRIEDLAND, 2855 PGA BOULEVARD, SUITE 200, PALM BEACH GARDENS, FL, 33410, US

(21) Appl. No.: 11/708,203

(22) Filed: Feb. 20, 2007

(51) Int. Cl. H02J 9/08

(52) U.S. Cl. 307/65; 307/64

(57) ABSTRACT

A system includes an electrical load formed by a number of circuits within a system performing telecommunication functions, primary and backup sources of electrical power, and a relay that switches an input to the electrical load from the primary source to the backup source in response to determining that a failure has occurred within the primary source. The backup source includes a microturbine driving a six-phase, high-frequency alternator, which is turned on in response to determining that such a failure has occurred, and, preferably, a battery array that provides backup power when adequate power is not available from the alternator driven by the microturbine.

### BACKGROUND OF THE INVENTION

1. Field of the Invention

This invention relates to a backup system generating electrical power within a telecommunications facility in the event of the failure of a primary source of power, such as an electrical utility, and, more particularly, to such a backup system including an alternator producing polyphase alternating current at a high frequency and a rectifier.

2. Summary of the Background Art

Telecommunications facilities, such as the local facilities providing cellular telephone service or wired connections to the wired, switched public telephone network within a surrounding area, typically include a backup system for providing power in the event of the failure of a primary source of electrical power, such as power from an electrical utility. In many locations, the only such source of backup power is an array of electrical batteries, which are only able to provide continuous power for a limited number of hours. While such an arrangement is satisfactory during a power outage of short duration, a system providing continuous electrical power during a much longer period is needed when extensive repairs must be made to the power distribution system of the electrical utility following a hurricane or an ice storm. When such repairs must be made to the power distribution system, the telecommunication system, relying on various forms of radio communications and underground cables for signal transmission, is often available for use if only electrical power can be made available for telecommunication purposes.

An alternator driven by a diesel engine is often used to provide backup electrical power during a failure of primary power from an electrical utility, with the speed of the diesel engine being controlled so that the alternator produces power at the frequency of local power distribution, such as 60 Hz. However, for the operation of a telecommunications facility, a source of ripple-free direct-current power is needed, so an expensive filtering system is additionally needed for backup power.

The patent literature includes a number of descriptions of systems including microturbines, burning natural gas supplied by a utility, or, in the event of the failure of such a fuel source, by stored butane gas, used to provide primary power for a telecommunications facility, with backup power being provided by a number of fuel cells powered by hydrogen. In the event of failure of the fuel cells, a secondary source of backup power is provided by electricity from a electric utility. Capacitors are used to provide power during the switching between other power sources. For example, such systems are described in U.S. Pat. Nos. 6,992,401, 6,781,250, and 7,098,548. A mobile power generating system, including a turbine used as a primary power source, a number of fuel cells used as a first backup power source, and a means for using power supplied from an electric utility as a second backup power source, is described in U.S. Pat. No. 7,112,891.

An electrical power generating system including a microturbine, a six-phase, high-frequency alternator, and a rectifier is described in U.S. Pat. No. 7,053, 590.

### SUMMARY OF THE INVENTION

According to a first aspect of the invention, a system is provided, including an electrical load, primary and backup sources of electrical power, a first voltage sensing circuit, and a first relay. The primary source of electrical power provides direct current to the electrical load, which comprises circuits providing telecommunications functions. The backup source of electrical power, which also provides direct current, includes a microturbine power generating system, in turn including a microturbine, an alternator driven by the microturbine, and a rectifier. The first voltage sensing circuit determines when a failure of the primary source occurs. The first relay switches the electrical load from the primary source to the backup source in response to a determination within the first voltage sensing circuit that a failure of the primary source has occurred.

Preferably, the voltage sensing circuit additionally determines when power from the primary source, which is, for example, connected to power lines from an electrical utility, has been restored following a failure of the primary source, with the first relay then switching from the backup source to the primary source.

Preferably, the backup source additionally includes a battery array, a second voltage sensing circuit, and a second relay. The second voltage sensing circuit determines when adequate electrical power is being developed within the microturbine generating system. The second relay switches the backup source of electrical power to the microturbine power generating system in response to a determination within the second voltage sensing circuit that adequate electrical power is being developed within the microturbine power generating system. Additionally, the second relay switches the backup source of electrical power to the battery array in response to a determination within that adequate electrical power is not being developed within the microturbine power generating system.

Preferably, the alternator is a six-phase, high-frequency device, with the microturbine electrical power generating system additionally including a six-phase transformer, having primary windings arranged in a pair of three-phase delta configurations and secondary windings arranged in a pair of three-phase wye configurations. For example, the alternator may produce six-phase alternating current having a frequency of approximately 2.267 kHz.

According to another aspect of the invention, a method is provided for providing backup power for an electrical load including circuits performing telecommunications functions. The method includes determining that a failure has occurred within a primary source of electrical power for the electrical load, and, in response to such a determination, switching an input to the electrical load from the primary source to a backup source of electrical power and starting a microturbine attached to an alternator to provide backup power for the backup source. The input is automatically switched, and the microturbine is automatically started in response to such a determination. In this context, automatically switching the input is understood to mean that the input is switched without operator intervention, and automatically starting the microturbine is understood to mean that the microturbine is started without operator intervention.

### BRIEF DESCRIPTION OF THE DRAWING

FIG. 1 is a schematic view of a system built in accordance with the invention to provide primary and backup DC electrical power for a load within a telecommunications facility

FIG. 2 is a schematic view of a microturbine electrical power generating system within the system of FIG. 1; and

FIG. 3 is a flow chart of process steps occurring during operation of the system of FIG. 1.

### DETAILED DESCRIPTION OF THE INVENTION

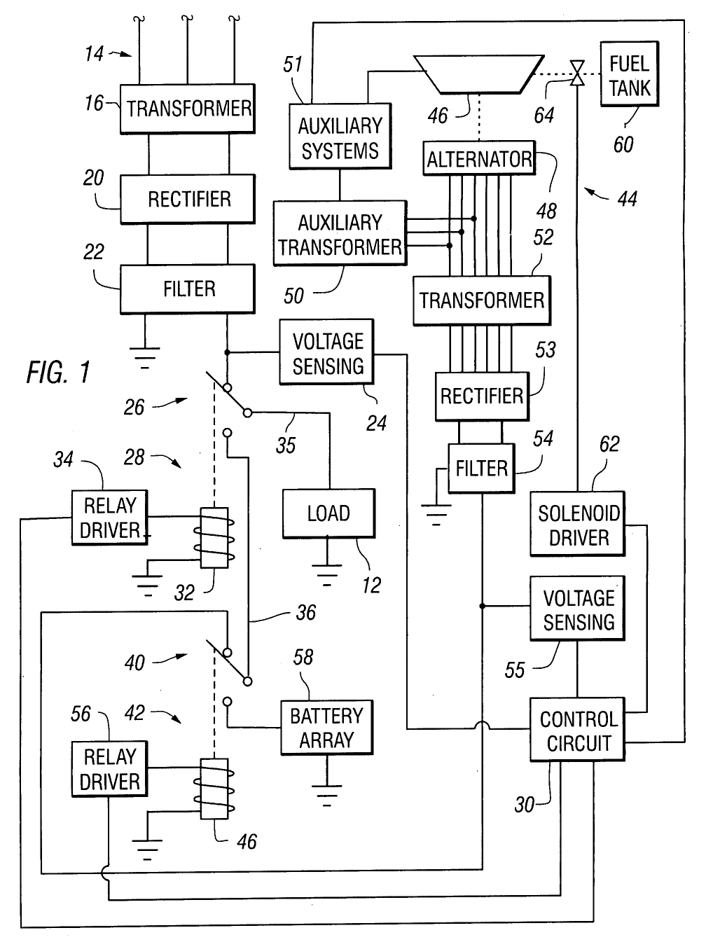

FIG. 1 is a schematic view of a system 10, built in accordance with the present invention to provide direct current (DC) primary and backup power for an electrical load 12, formed by equipment within a telecommunications system. For example, such equipment may provide cellular telephone access within a particular geographic area, or it may provide switching for a number of wired telephones.

A primary source of electrical power is provided through lines 14, which are, for example, three-phase lines from an electrical utility, providing inputs to a transformer 16. Three-phase current flowing within the output lines 18 from the transformer 16 is rectified to produce direct current within a rectifier 20, with the output of the rectifier 20 being applied to a filter 22 to remove the remaining alternating current ripple and other forms of electrical noise. The output of the filter 20 is directed to a voltage sensing circuit 24 and to the contacts 26 of a first relay 28, through which electrical current is supplied to the load 12. An output signal from the voltage sensing circuit 24 is applied as an input to a control circuit 30, which is configured to drive the coil 32 of the first relay 28 through a relay driver circuit 34 whenever the output signal from the voltage sensing circuit 24 indicates that the voltage of the current from the filter 22 has fallen below a level determined to indicate that backup current will be required to continue satisfactory operation of the circuits within the electrical load 12. Thus, the input line 35, which drives the electrical load 12 is switched between the primary source of electrical power and a backup source of electrical power, which is made available through line 36 in response to a determination that the primary source of electrical power has failed within the voltage sensing circuit 24, with this switching process being automatic in the sense that human intervention is not required.

When the relay coil 32 is actuated, electrical current is supplied to the load 12 through the contacts 40 of a second relay 42, with such electrical current being supplied from the output of a microturbine electrical power generating system 44 as long as the coil 46 of the second relay 42 is not actuated. The microturbine electrical power generating system 44 includes a microturbine 46 driving an alternator 48, an auxiliary transformer 50 providing electrical power for auxiliary systems 51 of the microturbine 46, a transformer 52 reducing the voltage of the output lines of the alternator 48, a rectifier 53 providing direct current to drive the electrical load 12, and a filter 54 removing the remaining alternating current ripple and other forms of electrical noise. Preferably, as described in U.S. Pat. No. 7,053,590, the disclosure of which is incorporated herein by reference, the alternator 48 is a six-phase high frequency device. The output current from the filter 54 is directed to the contacts 40 of the second relay 42, so that power from the microturbine system 44 is applied to the electrical load 12 when the coil 32 of the first relay 28 is actuated without actuating the coil 46 of the second relay 42.

The output voltage of the filter 54 is additionally applied to a voltage sensing circuit 55, which in turn provides a second input to the control circuit 30, so that the coil 46 of the second relay 42 is actuated through a relay driver 56 when the voltage supplied by the rectifier 53 is determined to be insufficient to provide for operation of the devices forming the electrical load 12. When the coil 46 is thus actuated with the coil 32 of the first relay 28 additionally being actuated, electrical power for the load 12 is provided from a battery array 58. The relays 28, 42 may be electromechanical devices or solid state switching devices.

The control circuit 30 applies a signal to the auxiliary systems 51 causing the microturbine 46 to be turned on and off as needed to supply backup power, and additionally controls a supply of fuel to the microturbine 46 from a fuel tank 60 through a solenoid driver circuit 62 operating a solenoid valve 64. The fuel may be a liquid or a compressed gas held within the tank 60. Alternately, natural gas supplied through a pipeline from a gas utility may be used.

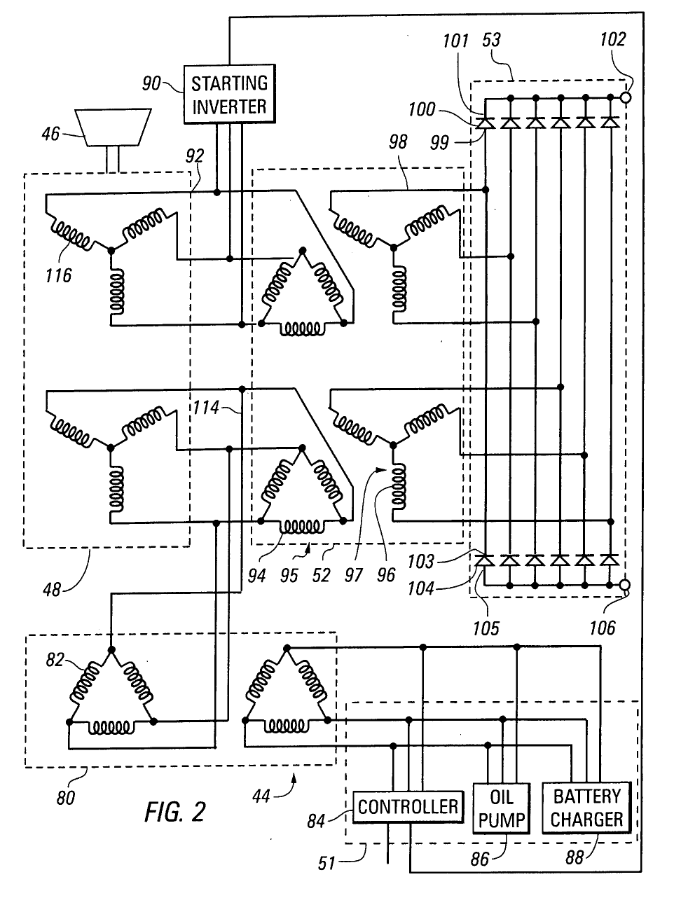

FIG. 2 is a schematic view of the microturbine electrical power generating system 44, including a high-frequency six-phase alternator 48, driven by the microturbine 46, the transformer 52, the rectifier 53 converting high-frequency alternating current to direct current, and the auxiliary transformer 50, formed as a three-phase transformer with primary windings 82. The auxiliary power supply 80 provides power for auxiliary systems 51 associated with operation of the microturbine 46, such as a controller 84, an oil pump 86 and a battery charger 88, which charges one or more batteries (not shown) to provide power for a starting inverter 90. The controller starts and stops operation of the microturbine 46 in response to an external input signal provided from the control circuit 30 (shown in FIG. 1). In response to a signal from the controller 84, the starting inverter 90 starts the microturbine 46 with the alternator 48 operating as a motor having a three-phase alternating current input applied at three of its terminals 92.

The transformer 52 includes primary windings 94, arranged in a pair of three-phase delta configurations 95, and secondary windings 96, arranged in a pair of three-phase wye configurations 97. The transformer 52 transforms a six-phase alternating current input having a voltage of approximately 600 volts into a six-phase alternating current output having a voltage of approximately 50 volts.

Within the rectifier 53, each of the output lines 98 from the transformer 52 is connected to a positive side 99 of a first diode 100, with the negative side 101 of the first diode 100 being connected to the positive output terminal 102 of the rectifier module 53. Additionally, the negative side 103 of a second diode 104 is connected to the positive side 99 of the first diode 100, with the positive side 105 of each of the second diodes 104 being connected to the negative output terminal 106 of the rectifier 53.

In an exemplary version of the microturbine electrical power generating system 44, the alternator 48 is a six-phase device with six windings 116 connected to phase lines 118, each of which provides an input for the rectifier module 53. The microturbine 46 is controlled by means of the controller 84 to operate at 68,000 rpm, so that alternating current is produced within the alternator 48 at a frequency of 2.267 kHz.

While ripple and noise suppression filtering is provided within the filter 54, the high operating frequency of the microturbine electrical power generating system 44, significantly reduces the size and cost of filtering devices when a comparison is made to the conventional use of a 50/60 Hz alternator powered by a diesel engine.

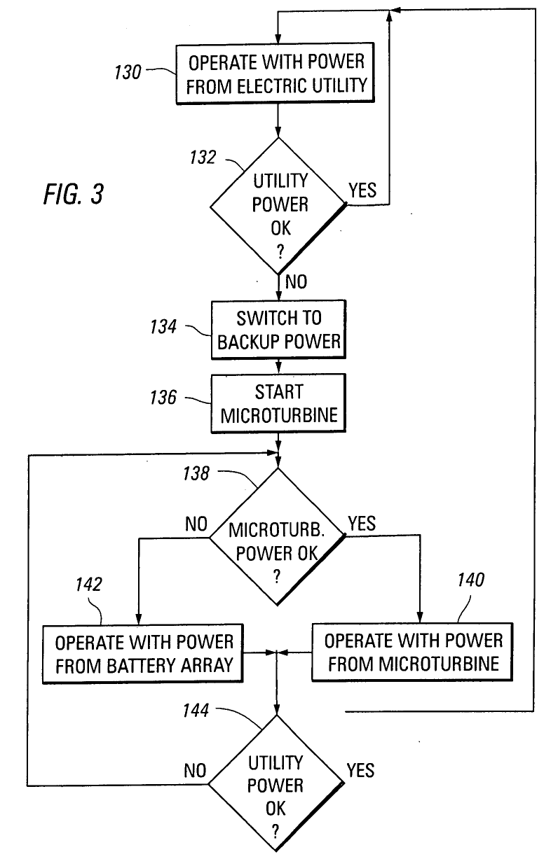

FIG. 3 is a flow chart of processes occurring within the system 10, with normal operation occurring in step 130 using the primary source of electrical power in the form of current flowing along lines 16 from an electrical utility. On a continuous or periodic basis, a determination is made in step 132 of whether the power from the utility is all right. If it is, operation of the system 10 is continued within step 130. If a failure of the power from the electrical utility is sensed using the voltage sensing circuit 24 the system 10 is switched to backup power in step 134 by actuating the coil 32 of the first relay 28, with the microturbine power system 44 being started in step 136. A further determination is made periodically or continuously in step in step 138 using the voltage sensing circuit 55, of whether the power from the microturbine power system 44 is all right. If it is, the system 10 is operated in step 140 with power from the microturbine system 44. Otherwise, the coil 46 of the second relay 42 is actuated, so that the system 10 operates with power from the battery array 58 in step 142. For example, power from the battery array 58 is used during the process of starting the microturbine power system 44, before its voltage output is stabilized, or if the microturbine power system 44 fails due to the exhaustion of its fuel supply. During operation with backup power from either the microturbine power system 44 or from the battery array 58, an additional determination is made in step 144 of whether the power from the utility system is again all right, using the voltage sensing circuit 24, indicating that a power failure is over. If it is all right, operation of the system 10 with power from the electric utility is restored by returning to step 130.

The control circuit 130 may include a processor executing instructions within a program to perform the process steps of FIG. 3. Alternately, the control circuit 130 may include logic gates arranged to switch in sequences performing these steps. The steps 132, 138, 144 of determining whether the utility power and the microturbine system power is all right may comprise a determination of a voltage condition over a time period, such as determined that a monitored voltage is within acceptable limits for a predetermined time period.

While the invention has been described in its preferred embodiment with some degree of particularity, it is understood that this description has been given only by way of example, and that many variations can be made without departing from the spirit and scope of the invention, as defined in the appended claims.

What is claimed is:

1. A system comprising:
an electrical load comprising circuits performing telecommunications functions;
a primary source of electrical power, providing direct current to the electrical load;
a first voltage sensing circuit determining when a failure of the primary source occurs;
a backup source of electrical power, providing direct current, including a microturbine power generating system, wherein the microturbine power generating system includes a microturbine, an alternator driven by the microturbine, and a rectifier,
a first relay, switching the electrical load from the primary source to the backup source in response to a determination within the first voltage sensing circuit that a failure of the primary source has occurred.

2. The system of claim 1, wherein
the voltage sensing circuit additionally determines when power from the primary source has been restored following a failure of the primary source, and
the first relay switches the electrical load from the backup source to the primary source in response to a determination that power from the primary source has been restored.

3. The system of claim 1, wherein the backup source additionally comprises:
a battery array;
a second voltage sensing circuit determining when adequate electrical power is being developed within the microturbine power generating system;
a second relay, switching the backup source to the microturbine power generating system in response to a determination within the second voltage sensing circuit that adequate electrical power is being developed within the microturbine power generating system and switching the backup source of electrical power to the battery array in response to a determination within that adequate electrical power is not being developed within the microturbine power generating system.

4. The system of claim 1, wherein the primary source is connected to power lines from an electrical utility.

5. The system of claim 1, wherein the alternator is a high-frequency six-phase device.

6. The system of claim 5, wherein the microturbine electrical power generating system additionally comprises a six-phase transformer connected between the alternator and the rectifier.

7. The system of claim 6, wherein the six-phase transformer includes primary windings arranged in a pair of three-phase delta configurations and secondary windings arranged in a pair of three-phase wye configurations.

8. The system of claim 5, wherein the alternator produces alternating current having a frequency of approximately 2.267 kHz.

9. A method for providing backup power for an electrical load, wherein the electrical load includes circuits performing telecommunications functions, and wherein the method comprises:
determining that a failure has occurred within a primary source of electrical power for the electrical load,
switching an input to the electrical load from the primary source to a backup source of electrical power for the electrical load, wherein the input is automatically switched in response to determining that the failure has occurred within the primary source of electrical power; and
starting a microturbine attached to an alternator within a microturbine electrical power generating system to provide electrical power for the backup source of electrical power, wherein the microturbine is automatically started in response to determining that the failure has occurred within the primary source of electrical power.

10. The method of claim 9, additionally comprising:
determining whether the microturbine power generating system is producing adequate electrical power; and
automatically switching the backup source of electrical power between the microturbine electrical power generating system, wherein the backup source of electrical power is switched to the microturbine power generating system in response to a determination that the microturbine power generating system is producing adequate electrical power, and wherein the backup source of electrical power is switched to a battery array in response to a determination that the microturbine power generating is not producing adequate electrical power.

11. The method of claim 9, additionally comprising:
determining, during operation of the electrical load with power from the backup source of electrical power, whether power from the primary source of electrical power has been restored, and
automatically switching the input to the electrical load from the backup source of electrical power to the primary source in response to determining that power from the primary source of electrical power has been restored.

12. The method of claim 9, wherein wherein the primary source of electrical power is connected to power lines from an electrical utility.

13. The method of claim 9, wherein the alternator is a high-frequency six-phase device.

14. The method of claim 13, wherein the microturbine electrical power generating system additionally comprises a six-phase transformer connected between the alternator and the rectifier.

15. The method of claim 14, wherein the six-phase transformer includes primary windings arranged in a pair of three-phase delta configurations and secondary windings arranged in a pair of three-phase wye configurations.

16. The method of claim 15, wherein the alternator produces alternating current having a frequency of approximately 2.267 kHz.

17. A backup power system for providing backup electrical power for an electrical load comprising circuits performing telecommunication functions, wherein the backup power system comprises a microturbine power generating system including:
a microturbine;
an alternator driven by the microturbine; and
a rectifier.

18. The backup power system of claim 17, additionally comprising:
a battery array;
a relay switching a source of backup power between the microturbine power generating system and the battery array;
a circuit determining whether the microturbine power generating system is producing adequate electrical power; and
a circuit automatically switching the relay, wherein the backup source of electrical power is switched to the microturbine power generating system in response to a determination that the microturbine power generating system is producing adequate electrical power, and wherein the backup source of electrical power is switched to a battery array in response to a determination that the microturbine power generating is not producing adequate electrical power.

19. The backup power system of claim 17, wherein the alternator is a high-frequency six-phase device.

20. The backup power system of claim 19, wherein the microturbine electrical power generating system additionally comprises a six-phase transformer connected between the alternator and the rectifier.
